(19) United States
(12) Patent Application Publication
(10) Pub. No.: US 2001/0002274 A1
(43) Pub. Date: May 31, 2001

(54) METAL STRIP COATING PROCESS

(76) Inventors: PETER LESSMEISTER, MUNSTER (DE); JOSEF RADEMACHER, BEVERLY HILLS, MI (US)

Correspondence Address: BASF CORPORATION, PATENT DEPARTMENT, 26701 TELEGRAPH ROAD, SOUTHFIELD, MI, 480342442

(21) Appl. No.: 09/043,208

(22) PCT Filed: Jun. 13, 1997
(86) PCT No.: PCT/EP97/03086

§ 371 Date: None

(30) Foreign Application Priority Data
Aug. 12, 1996 (DE) 196 32 426.2
Jun. 14, 1996 (DE) 196 23 717.3

(51) Int. Cl. B05D 3/02; B05D 1/06

(52) U.S. Cl. 427/195; 427/485; 427/289; 427/386; 427/385.5; 427/327

(57) ABSTRACT

Method of coating metal strips, preferably made of steel or aluminum, by applying a powder coating, cleaning, and baking, where

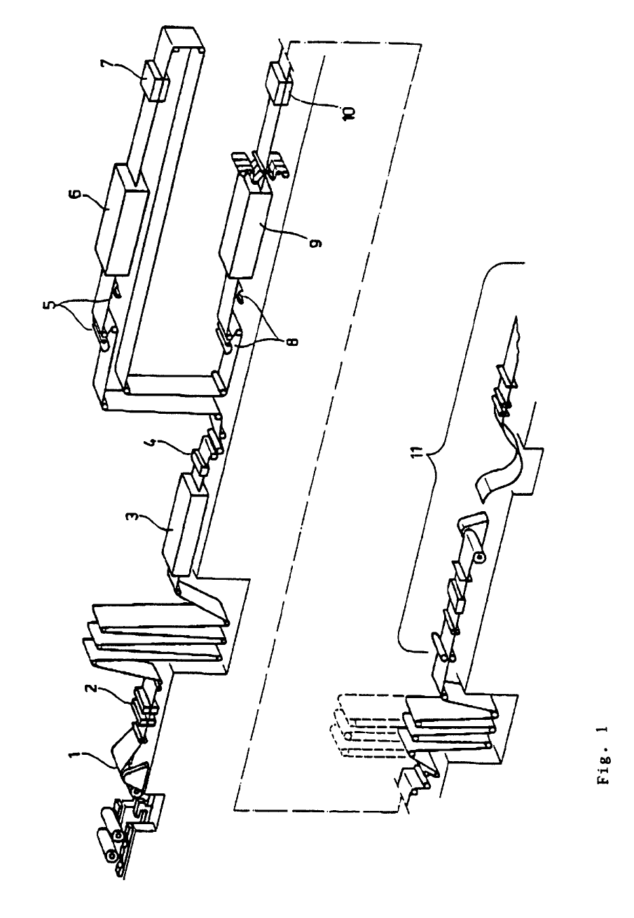

1) the powder coating comprises at least one polyhydroxy-functional resin or at least one epoxy resin, and

2) the powder coating has a particle size distribution such that

a) at least 90 percent by mass of the powder coating particles have a size of between 1 and 150, preferably 1 and 100 μm,

b) the maximum size of the powder coating particles for at least 99 percent by mass of the particles is ≦150 μm,

c) the mean size of the powder coating particles is between >5 and 60 μm, preferably 5 and 40 μm, and

d) the slope of the particle distribution curve at the point of inflection is ≧50, preferably ≧100.

The present invention relates to a method of coating metal strips, preferably made of steel or aluminum.

### PRIOR ART

The abovementioned method of coating metal strips is known in the language of the art by the term “coil coating”. In such methods metal sheets, preferably made of steel or aluminum, are cleaned, given a coating and then passed on for further processing.

The major areas of application are trapezoidal profiles coated with weather-resistant coating materials for facings and roofs and also doors, window frames, gates, guttering, blinds and the like. For the interior architectural sector, coil-coated metal sheets are used principally for dividing walls and for ceiling elements. Other areas of use, however, include steel furniture, shelving, shop fitting and appliance panels. Lamps and lighting form a further important application sector. There is also a broad range of application in the automotive sector. Truck bodies and “bolt-on” automotive components are frequently manufactured from precoated materials.

For coating the substrate employed it is common to carry out a pretreatment. As the first coating layer, a primer is frequently applied in a film thickness of from 5 to 10 μm on what will subsequently be the visible side. After a first pass through the drier, the actual topcoat is then applied, which after drying has a film thickness of about 20 μm. To protect against mechanical damage this surface is sometimes also laminated with a temporary protective film in the hot state. In parallel with the coating of the visible sides, the reverse sides are also coated, so that here too an appropriate protective film is applied. Polyester resins, for example, are employed as primers. For the use of coil-coated facings and roofs in a corrosive industrial climate the primers employed are systems comprising epoxy resin.

Liquid coating materials in innumerable colors are employed primarily as the topcoat. Depending on the field of use polyester and polyurethane topcoats, for example, are employed. The normal film thicknesses of the topcoats are generally about 20 μm.

In addition to the abovementioned liquid primers and topcoats it is also known to use powder coatings to coat metal strips in the coil-coating process. Powder coatings have the great advantage over the liquid coating materials that they are solvent free and hence more environmentally friendly. In comparison with the above-described liquid coating materials, however, a disadvantage is that the powder coating film thicknesses required are very high. They are in fact between 40 and 50 μm. If the powder coatings are applied more thinly the coating is no longer free from pores. This leads to optical defects and to points of corrosive attack.

### GENERAL DESCRIPTION OF THE INVENTION

The object of the present invention, then, is to provide a method of coating metal strips, preferably made of steel or aluminum by cleaning them, applying a powder coating, and baking, that makes it possible to obtain film thicknesses of less than 20 μm, preferably less than 15 μm, with particular preference, less than 10 μm.

This object is achieved by the fact that

1) the powder coating comprises at least one polyhydroxy-functional resin and/or at least one epoxy resin, and

2) the powder coating has a particle size distribution such that

a) at least 90 percent by mass of the powder coating particles have a size of between 1 and 100, preferably 1 and 50 μm,

b) the maximum size of the powder coating particles for at least 99 percent by mass of the particles is ≦150 μm,

c) the mean size of the powder coating particles is between >5 and 60 μm, preferably 5 and 40 μm, and

d) the slope of the particle distribution curve at the point of inflection is ≧50, preferably ≧100.

In a preferred embodiment the powder coating has a particle size distribution such that

a) at least 90 percent by mass of the powder coating particles have a size of between 1 and 60 μm, preferably between 1 and 40 μm,

b) the maximum size of the powder coating particles for at least 99 percent by mass of the particles is ≦100 μm, preferably ≦60,

c) the mean size of the powder coating particles is between 5 and 20 μm, preferably between 5 and 12 μm, and

d) the slope of the particle distribution curve at the point of inflection is ≧100, preferably ≧150.

In a further preferred embodiment the particle size distribution is such that

a) at least 90 percent by mass of the powder coating particles have a size of between 5 and 25 μm,

b) the maximum size of the powder coating particles for at least 99 percent by mass of the particles is ≦40 μm,

c) the mean size of the powder coating particles is between 5 and 12 μm, and

d) the slope of the particle distribution curve at the point of inflection is ≧200.

The Components of the Powder Coating

In the text below the individual components of the powder coatings of the invention will first of all be elucidated further.

Examples of polyhydroxy-functional resins that can be employed are polyester, polyether, polyurethane, polyacrylate and/or polysiloxane resins having weight-average molecular weights Mw of between 500 and 200,000, preferably between 1000 and 100,000 daltons.

Suitable polyhydroxy-functional polyesters A (polyesterpolyols) are prepared, for example, by esterifying organic dicarboxylic acids or their anhydrides with organic di- and/or polyols, in the course of which the formation of branching sites must be suppressed at the expense of free hydroxyl groups in the polyester. As dicarboxylic acids it is preferred to employ aliphatic, cycloaliphatic saturated or unsaturated and/or aromatic dibasic carboxylic acids, and also their anhydrides and/or their esters. Mention may be made by way of example of: phthalic acid (anhydride), isophthalic acid, terephthalic acid, tetrahydro- or hexahydrophthalic acid (anhydride), endomethylene-tetrahydrophthalic acid, succinic acid, glutaric acid, sebacic acid, azeleic acid, fumaric and maleic acid. The most common are isophthalic acid and phthalic acid (anhydride). As polyol units it is preferred to use aliphatic, cycloaliphatic and/or aralaliphatic alcohols having 1 to 6, preferably 1 to 4 hydroxyl groups attached to nonaromatic carbon atoms. As exemples of [lacuna] there may be mentioned: ethylene gglycol [sic], 1,2- and 1,3-propanediol, 1,2- , 1,3- and 1,4 butanediol, 2-ethyl-1,3-propanediol, 2-ethyl-1,3-hexanediol, 1,3-neopentyl [sic] glycol, 2,2-dimethyl-1,3-pentanediol, 1,6-hexanediol, 1,2- and 1,4-cyclohexane-diol, 1,2- and 1,4-bis(hydroxymethyl)cyclohexane, adipic acid bis(ethylene glycol ester), ether alcohols, such as di- and triethylene glycol, dipropylene glycol, perhydrogenated bisphenols, 1,2,4-butanetriol, 1,2,6-hexanetriol, trimethylolethane, trimethylol-propane, trimethylolhexane, glycerol, pentaerythritol, dipentaerythritol, mannitol and sorbitol, and also chain-terminating monoalcohols having 1 to 8 carbon atoms, such as propanol, butanol, cyclohexanol, benzyl alcohol and hydroxypivalic acid. Alcohols preferably employed are: glycerol, trimethylolpropane, neopentyl glycol and pentaerythritol.

As polyetherpolyols A it is possible, for example, to employ polyalkylene ethers having 2 to 6 carbon atoms and at least one free hydroxyl group per alkylene unit, the number of repeating alkylene units per polymer molecule being between 2 and 100, preferably between 5 and 50. Examples are poly-2-hydroxy-1,3-propylene oxide, poly-2- or poly-3-hydroxy-1,4,-butylene oxide.

Units of the polyhydoxy-functional poly-urethanes A (polyurethanepolyols) can, for example, be the aliphatic, cycloaliphatic and/or aralaliphatic alcohols already described above having 1 to 6, preferably 1 to 4 hydroxyl groups attached to nonaromatic carbon atoms. It is also possible to employ the above-described polyesterpolyols themselves as polyurethane units, in which case it must be ensured that the initially specified molecular weight limits Mw of 500 to 200,000, preferably from 1000 to 100,000 daltons are not exceeded in the course of the synthesis of the polyurethanepolyol as a result, for example, of crosslinking.

As examples of polyhydroxy-functional polyacrylates A (polyacrylatepolyols) there may be mentioned those comprising as comonomer units preferably hydroxyalkyl esters of acrylic acid, methacrylic acid or of another alpha, beta-ethylenically unsaturated carboxylic acid. These esters can be derived from an alkylene glycol, which is esterified with the acid, or can be obtained by reacting the acid with an alkylene oxide. Hydroxyalkyl esters employed are preferably hydroxyalkyl esters of (meth)acrylic acid in which the hydroxylalkyl group contains up to 4 carbon atoms, or mixtures of these hydroxyalkyl esters. Examples which may be mentioned are: 2-hydroxyethyl (meth)acrylate, 2- or 3-hydroxypropyl (meth)acrylate or 4-hydroxybutyl (meth)acrylate. As further comonomer units the polyacrylatepolyols can contain, for example, aliphatic, cycloaliphatic, aromatic and/or araliphatic (meth)acrylates having up to 20 carbon atoms in the ester radical, for example: methyl (meth)acrylate, ethyl (meth)acrylate, propyl (meth)acrylate, butyl (meth)acrylate, isobutyl (meth)acrylate, tert-butyl (meth)acrylate, hexyl (meth)acrylate, 2-ethylhexyl (meth)acrylate, stearyl (meth)acrylate, lauryl (meth)acrylate, cyclohexyl (meth)acrylate, cyclopentyl (meth)acrylate, cyclooctyl (meth)acrylate, phenyl (meth)acrylate, 2-phenylethyl (meth)acrylate or 3-phenylpropyl (meth)acrylate. It is also possible to employ vinylaromatic hydrocarbons, such as styrene, alpha-alkylstyrene and vinyltoluene, and also (meth)acrylamides and/or (meth)acrylonitrile as comonomer units in the polyacrylatepolyols A.

As polyhydroxy-functional polysiloxanes A (polysiloxanepolyols) it is preferred to use organopolysiloxanes having hydroxy-functional substituents. Examples which may be mentioned are methylhydroxyethylpolysiloxane, methyl-3-hydroxy-propylpolysiloxane or ethyl-3-hydroxypolysiloxane [sic]. Organopolysiloxanes of this kind can also be present as oligomeric and/or polymeric units in the above-described polyhydroxy-functional resins A. Regarding the organopolysiloxanes mentioned compare, for example, Ullmanns Enzyklopädie der technischen Chemie, 4th ed., Volume 21, pages 520 to 510, Verlag Chemie, Weinheim, Deerfield Beach, Basel, 1982.

Epoxy resins

Suitable epoxy components are preferably all aromatic, aliphatic and/or cycloaliphatic epoxy resins having epoxide equivalent weights of between 300 and 5500, preferably 400 and 3000, particularly preferably between 600 and 900 and, with very particular preference between 700 and 800. Preference is given to using epoxy resins based on bisphenol A, and/or epoxidized novolak resins. Here, the epoxy resins based on bisphenol A generally have a functionality ≦2, the epoxidized novolak resins a functionality ≧2.

In this context, epoxy resins based on bisphenol A and/or bisphenol F generally have a functionality of not more than 2 and epoxy resins of the novolak type have a functionality which is in general at least 2. However, the epoxy resins based on bisphenol A and/or bisphenol F may also be brought to a functionality of more than 2 by branching with, for example, trimethanolpropane glycerol, pentaerythritol or other branching reagents.

It is of course also possible to employ other epoxy resins, such as alkylene glycol diglycidol ethers or their branched successor products, bisphenol A- and/or F-based epoxy resins flexibilized with alkylene glycols, or the like. Also suitable, furthermore, are mixtures of various of said epoxy resins.

Examples of suitable epoxy resins are the products obtainable commercially under the following names: Epikot^{R} 154, 1001, 1002, 1055, 1004, 1007, 1009, 3003-4F-10 from Shell-Chemie, XZ 86 795 and DER 664, 667, 669, 662, 642U and 672U from Dow, and Araldit XB 4393, XB 4412, GT 7072, GT 7203, GT 7004, GT 7304, GT 7097 and GT 7220 from Ciba Geigy.

Further additives

As a further component the powder coating of the invention comprises at least one curing catalyst, usually in an amount of from 0.01 to 5.0% by weight, preferably from 0.05 to 2% by weight, based in each case on the overall weight of the powder coating.

The powder coatings described that are based on polyhydroxy-functional resins or epoxy resins may also include from 0 to 40% by weight, preferably from 15 to 25% by weight, of fillers.

The fillers generally employed are inorganic fillers, for example titanium dioxide, such as Kronos 2160 from Kronos Titan, Rutil® 902 from Du Pont and RC 566 from Sachtleben, barium sulfate, and silicate-based fillers, such as talc, kaolin, magnesium aluminum silicates, micas and the like. Preference is given to the use of titanium dioxide and fillers of the quartz sand type.

The powder coatings can if desired also comprise, furthermore, from 0.01 to 10% by weight, preferably from 0.1 to 2% by weight, based on the overall weight of the powder coating, of further auxiliaries and additives. Examples of these are leveling agents, flow aids, deaerating agents, such as benzoin, pigments or the like.

Polyester and epoxy resin-containing powder coatings

The polyesters employed in powder coatings based on polyester and epoxy resin have an acid number of from 25 to 120 mg of KOH/g, preferably from 30 to 90 mg of KOH/g and, with particular preference, from 60 to 90 mg of KOH/g and an OH number of at least 10 mg of KOH/g, preferably at least 15 mg of KOH/g and preferably [sic]≦30 mg KOH/g. It is preferred to employ polyesters having a functionality ≧2. The number-average molecular weights of the polyesters are generally between 1000 and 10,000, preferably between 1300 and 5000. The abovementioned polyesters are preferably employed here. Particular preference is given to FDA-approved (FDA=Food and Drug Administration) polyesters. The carboxyl- and hydroxyl-containing polyesters can in this case be prepared by the customary methods (cf. e.g. Houben Weyl, Methoden der organischen Chemie, 4th edition, volume 14/2, Georg Thieme Verlag, Stuttgart 1961).

The polyester component is usually employed in an amount of from 19 to 80% by weight, preferably from 39 to 60% by weight based on the overall weight of the powder coating. The epoxy resin component in the powder coatings of the invention is usually employed in an amount of from 19 to 80% by weight, preferably from 39 to 60% by weight, based on the overall weight of the powder coating.

Accordingly, in one preferred embodiment of the method of the invention a powder coating is employed,

1) which comprises

A) at least one polyester having an acid number of from 25 to 120 mg of KOH/g and an OH number ≧10 mg of KOH/g, and

B) at least one epoxy resin having an epoxide equivalent weight of from 300 to 5500 and

2) which has a particle size distribution such that

a) at least 90 percent by mass of the powder coating particles have a size of between 1 and 60 μm,

b) the maximum size for at least 99 percent by mass of the powder coating particles is ≦100

c) the mean size of the powder coating particles is between 5 and 20 μm, and

d) the slope of the particle distribution curve at the point of inflection is greater than or equal to 100.

In accordance with the invention it is also possible to employ a powder coating, based on epoxy resins and carboxyl-containing polyesters,

1) which comprises

A) at least one polyester having an acid number of from 25 to 120 mg of KOH/g and an OH number >10 mg of KOH/g, and

B) at least one epoxy resin having an epoxide equivalent weight of from 400 to 3000 and

2) which has a particle size distribution such that

a) at least 90 percent by mass of the powder coating particles have a size of between 1 and 100 μm,

b) the maximum size for at least 99 percent by mass of the powder coating particles is ≦150 μm,

c) the mean size of the powder coating particles is between >20 and 60 μm, and

d) the slope of the particle distribution curve at the point of inflection is ≧50.

The powder coating additionally comprises at least one curing catalyst. The catalyst is advantageously imidazole, 2-methylimidazole, ethyl-triphenylphosphonium chloride or another salt thereof, a quinoline derivative, as described for example in EP-B-10805, a primary, secondary or tertiary aminophenol, aluminum acetylacetonate or a toluene sulfonic acid salt or a mixture of various of said catalysts.

The commercially available carboxyl- and hydroxyl-containing polyester resins normally already include the required curing catalyst. Examples of such commercial carboxyl- and hydroxyl-containing polyesters that are employed with particular preference are the products obtainable commercially under the following brand names: Crylcoat 314, 340, 344, 2680, 316, 2625, 320, 342 and 2532 from UCB, Drogenbos, Belgium, Grilesta 7205, 7215, 72-06, 72-08, 72-13, 72-14, 73-72, 73-93 and 7401 from Ems-Chemie, and Neocrest P 670, P 671, P 672, P678 and P 662 from ICI.

Powder coatings based on epoxy resins and phenolic hardeners

In a further embodiment the method of the invention employs a powder coating based on epoxy resins and phenolic hardeners,

1) which comprises

A) at least one epoxy resin having an epoxide equivalent weight of from 300 to 5500, and

B) at least one hardener having more than one phenolic hydroxyl group per molecule and a hydroxyl equivalent weight, based on phenolic OH groups, of from 100 to 500, and

2) which has a particle size distribution such that

a) at least 90 percent by mass of the powder coating particles have a size of between 1 and 60 μm,

b) the maximum size for at least 99 percent by mass of the powder coating particles is ≦100 μm,

c) the mean size of the powder coating particles is between 5 and 20 μm, and

d) the slope of the particle distribution curve at the point of inflection is >100.

The epoxy resin component is normally employed in the above-described powder coating in an amount of from 29 to 80% by weight, preferably from 39 to 60% by weight, based in each case on the overall weight of the powder coating. The hardener component is normally employed in the powder coating of the invention in an amount of from 10 to 50% by weight, preferably from 15 to 40% by weight, based in each case on the overall weight of the powder coating.

It is preferred that the powder coating employed comprises

from 19 to 80% by weight of the epoxy resin component A,

from 10 to 50% by weight of the hardener component Ba) or

from 19 to 80% by weight of the polyester component Bb)

the percentages being based in each case on the overall weight of the powder coating.

These powder coatings are known and are described in DE-A-42 04 266, page 3, line 39, to page 6, line 38, and in DE-A-40 38 681, page 3, line 55 to page 5, line 16.

Suitable epoxy resins are, for example, the products obtainable commercially under the abovementioned name.

Preference is given to the use of aromatic epoxy resins based on bisphenol A and/or bisphenol F, and/or epoxy resins of the novolak type. Epoxy resins based on bispenol A or bisphenol F that are employed with particular preference have an epoxide equivalent weight of from 500 to 2000. Epoxy resins of the novolak type that are employed with particular preference have an epoxide equivalent weight of from 500 to 1000.

Suitable hardener components are all solid compounds having more than one phenolic OH group, preferably from 1.8 to 4, with particular preference≦3 and, with very particular preference, from 1.8 to 2.2 phenolic OH groups per molecule, and a hydroxyl equivalent weight, based on phenolic OH groups, of from 100 to 500, preferably from 200 to 300.

Preferred hardeners are those based on bisphenol A and/or bisphenol F. Particular preference is given as hardener to the condensation product of the diglycidol ether of bisphenol A and/or bisphenol F with bisphenol A and/or bisphenol F, respectively, especially the condensation product having an equivalent weight—based on phenolic hydroxyl groups—of from 220 to 280. These condensation products are normally prepared by reacting bisphenol, generally in excess, with a bisphenol diglycidyl ether in the presence of an appropriate catalyst. The condensation product is preferably prepared by reacting the diglycidyl ether with the bisphenol in a weight ratio of from 0.5 to 2. These hardeners based on said condensation products of the bisphenol diglycidyl ether with a bisphenol generally have a functionality of not more than 2, it being possible again to establish higher functionalities by using branching reagents. Also suitable as hardeners, furthermore, are the reaction products of bisphenols with epoxy resins of the novolak type. These hardeners are preferably obtained by reacting the epoxy resin with the bisphenol in a weight ratio of from 0.5 to 2 in the presence of an appropriate catalyst. Suitable phenolic hardeners are those, for example, described in DE-C-23 12 409 in column 5, line 2 to column 6, line 55. These polyphenols correspond to the following general formulae

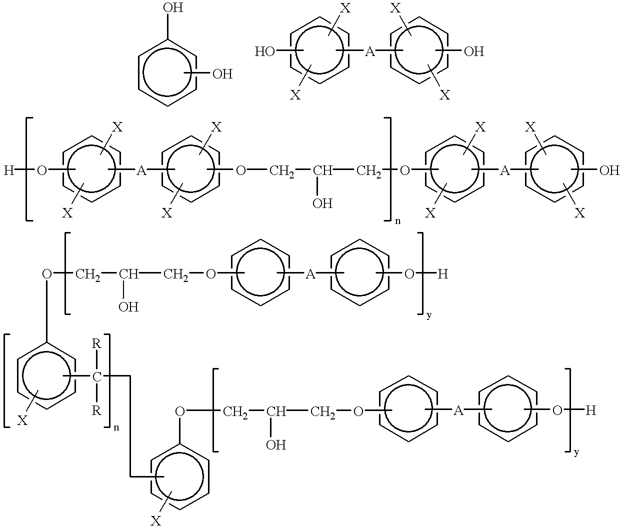

in which A is a divalent hydrocarbon radical having 1 to 6 C atoms or is the radicals

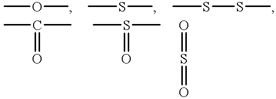

x is a hydrogen or an alkyl radical having 1 to 4 C atoms,

n adopts an average value from 1 to 9, preferably from 2 to 7, and

y adopts a value of 0 or 1.

Furthermore, it is also possible to employ the phenolic hardeners described in DE-A 30 27 140.

Also suitable of course are flexibilized hardeners and/or hardeners modified with branching reagents. Mixtures of various of said hardeners can also be employed, furthermore. Preference is given in this context to the use of FDA-approved hardeners.

As a further component the above-described powder coatings include at least one curing catalyst. The catalysts employed are advantageously those that are also suitable for the powder coatings based on epoxy resins and polyester resins.

Normally, the hydroxyl-containing hardeners obtainable commercially already include a curing catalyst. Examples of such commercial, hydroxyl-containing hardeners, which are preferably employed, are the products obtainable commercially under the following names: D.E.H^{.R} 81, 82 and 84 from Dow, Harter [hardener] XB 3082 from Ciba Geigy and Epikure^{R} 169 and 171 from Shell-Chemie.

Powder coatings based on polyhydroxy-functional resins and polyisocyanates

In another embodiment of the invention use is made of a powder coating which is based on polyhydroxy-functional resins and polyisocyanate hardeners and

1) which comprises

A) at least one polyhydroxy-functional resin having a hydroxyl number of between 5 and 200 mg of KOH/g, and

B) at least one polyisocyanate hardener having more than one isocyanate group per molecule and

2) which has a particle size distribution such that

a) at least 90 percent by mass of the powder coating particles have a size of between 1 and 60 μm,

b) the maximum size for at least 99 percent by mass of the powder coating particles is ≦100 μm,

c) the mean size of the powder coating particles is between 5 and 20 μm, and

d) the slope of the particle distribution curve at the point of inflection is 100.

The polyhydroxy-functional resin is employed in the powder coatings of the invention normally in an amount of from 10 to 90% by weight, preferably from 29 to 80% by weight, based in each case on the overall weight of the powder coating. The hardening component is employed in the powder coatings of the invention normally in an amount of from 10 to 80% by weight, preferably from 10 to 50% by weight, based in each case on the overall weight of the powder coating.

The polyhydroxy-functional resins that are employed in the powder coatings are solid polymer resins which are composed of the components already described above.

As polyisocyanate component in the synthesis of the polyurethanepolyols A it is possible to employ aliphatic and/or cycloaliphatic and/or aromatic diisocyanates. Examples of the aromatic diisocyanates preferably employed are phenylene diisocyanate, tolylene diisocyanate, xylylene diisocyanate, biphenylene diisocyanate, naphthylene diisocyanate and diphenylmethane diisocyanate. Examples of cycloaliphatic polyisocyanates are isophorone diisocyanate, cyclopentylene diisocyanate and the hydrogenation products of the aromatic diisocyanates, such as cyclohexylene diisocyanate, methylcyclohexylene diisocyanate and dicyclohexylmethane diisocyanate. Example [sic] of aliphatic diisocyanates are are [sic] trimethylene diisocyanate, tetramethylene diisocyanate, pentamethylene diisocyanate, hexamethylene diisocyanate, propylene diisocyanate, ethylethylene diisocyanate, dimethylethyl diisocyanate, methyltrimethylene diisocyanate and trimethylhexane diisocyanate. A further example of an aliphatic diisocyanate is tetramethylxylene diisocyanate.

Suitable hardener components are aliphatic and/or cycloaliphatic and/or aromatic polyisocyanates, preferably in the solid aggregate state at application temperature. Examples of the aromatic polyisocyanates preferably employed are phenylene diisocyanate, tolylene diisocyanate, xylylene diisocyanate, biphenylene diisocyanate, naphthylene diisocyanate and diphenylmethane diisocyanate.

Examples of cycloaliphatic polyisocyanates are isophorone diisocyanate, cyclopentylene diisocyanate and the hydrogenation products of the aromatic diisocyanates, such as cyclohexylene diisocyanate, methylcyclohexylene diisocyanate and dicyclohexylmethane diisocyanate. Aliphatic diisocyanates are compounds of the formula

OCN—(CR³₂)r—NCO [sic]

in which r is an integer from 2 to 20, in particular from 6 to 8 and R³, which can be identical or different is hydrogen or a lower alkyl radical having 1 to 8 C atoms, preferably 1 or 2 C atoms. Examples thereof are trimethylene diisocyanate, tetramethylene diisocyanate, pentamethylene diisocyanate, hexa-methylene diisocyanate, propylene diisocyanate, ethylethylene diisocyanate, dimethylethyl diisocyanate, methyltrimethylene diisocyanate and trimethylhexane diisocyanate. A further example of an aliphatic diisocyanate is tetramethylxylene diisocyanate.

In addition to diisocyanates the hardener component may also include a proportion of polyisocyanates having functionalities of more than two, such as triisocyanates, for example. Products which have proven suitable as triisocyanates are those formed by trimerization or oligomerization of diisocyanates or by reaction of diisocyanates with polyfunctional compounds containing OH or NH groups. These include, for example, the biuret of hexamethylene diisocyanate and water, the isocyanurate of hexa-methylene diisocyanate, or the adduct of isophorone diisocyanate with trimethylolpropane. The average functionality can be lowered if desired by adding mono-isocyanates. Examples of such chain-terminating mono-isocyanates are phenol isocyanate, cyclohexyl isocyanate and stearyl isocyanate.

Flexibilized hardeners and/or hardeners modified with branching reagents are of course also suitable. It is possible in addition to employ mixtures of various of said hardeners.

As a further component the powder coatings of the invention comprise at least one curing catalyst. The catalyst is advantageously selected from the group of the compounds which catalyze the reaction of isocyanate groups with hydroxyl groups to give urethane groups, examples being dibutyltin dilaurate, dibutyltin maleate or mixtures of various of said catalysts.

The preparation of the powder coating

The powder coating is prepared by the known methods (cf. e.g. product information bulletin from BASF Lacke+Farben AG, “Pulverlacke” [powder coatings], 1990) by homogenization and dispersion using, for example, an extruder, screw compounder, and the like. It is essential to the invention that the powder coatings, following their preparation, are brought by grinding and, if appropriate, by classifying and sieving to a particle size division [sic] adapted to the intended application.

For use for the coating of metal strips the particle size distribution is established in accordance with the above information. It is also essential to the invention that, when the powder coatings are used to coat metal strips, the particle size distribution is established such that the slope S of the particle distribution curve at the point of inflection exhibits the values specified above. With particular preference the range is ≧200. To obtain coatings having particularly good properties, it is very particularly preferred to employ powder coatings for which the slope S of the particle size distribution curve at the point of inflection is ≦300.

The slope S here is defined as the limit value for f(x₂)−f(x₁) toward zero of (f(x₂)−f(x₁))/lg ((x₂/x₁)) at the point of inflection of the particle distribution curve. The particle distribution curve represents the plot of the cumulative percentages by mass (F(x)) against the absolute particle diameter (x), with the particle diameter being represented on the logarithmic scale and the cumulative percentages by mass on the linear scale.

The establishment of the respective particle size distribution of the powder coatings takes place with suitable grinding apparatus, alone or in combination with appropriate classifying and sieving equipment; for example, with fluidized bed countercurrent mills (AFG) from Alpine, Augsburg, in combination with turboplex ultrafine classifiers from Alpine, Augsburg.

In a further embodiment it is possible to employ powder coatings consisting of an unsaturated polyester and of a polyurethane that contains (meth)acrylic groups. Corresponding compositions are known, for example, from EP-A-0 585 742.

The powder coatings are customarily baked at from 200 to 350° C. for a period of from 40 to 10 s. Particular preference is given to the ranges from 250 to 300° C. with a baking time of from 22 to 14 s.

The powder coatings described are applied, in accordance with the invention, to various substrates. If required it is possible to draw a peelable protective film over the powder coatings. Examples of films suitable for this purpose are those made from polyolefins, polyamides, polyurethanes, polyesters, polyacrylates, polycarbonates or a mixture of these polymeric substances. Polymer films of this kind normally have thicknesses of from 10 to 500, preferably from 20 to 200 μm.

Owing to the diverse utility, a very wide variety of carrier materials are employed as substrates for the coil-coating method of the invention. The first selection criterion which must be taken into account is the subsequent mechanical machining steps. Flanging, bending and deep drawing require certain qualities and strengths which must be ensured by way of the appropriate steel alloy or aluminum alloy. A further important criterion is the subsequent field of use. Steel products not exposed to massive corrosive attack can be processed by coil coating without further upgrading beforehand. In the case of greater humidity and climatic exposure, electrolytically galvanized or hot-dip galvanized material is employed. In addition to normal galvanizing, an important role is played here by the high-aluminum variants Galfan and Galvalume. Other than steel, aluminum is an important carrier material that can be employed in accordance with the invention. Before being coated with the powder coating of the invention, the substrate must be prepared for the coating process by means of an adequate pretreatment. Such pretreatments include, above all, cleaning and similar pretreatment steps.

The method of coating metal strips is described in more detail below with reference to the figures:

First of all, the metallic carrier material is uncoiled by the unwinder reel 1. This is followed by the mechanical joining of the beginning of the strip to be treated to the end of the strip 2 that is in the process of being coated.

Prior cleaning 3 is carried out in order to ensure a good level base. The metal is pretreated with various chemicals. Cleaning is usually conducted with acidic or alkaline solutions.

In a further treatment stage 4 the metal is rinsed, neutralized and dried. In stage 5 the coating is applied, with the strip being coated on either one or both sides. Application here takes place in accordance with known methods, as are described, for example, in U.S. Pat. No. 4,183,974. The electrostatic charging of the powder particles takes place by friction (triboelectricity) or electrostatic charging (corona technique).

After the coating has been applied the coated metal passes through the oven 6. Cooling takes place in the section 7. If desired, a second coating station 8 can be provided in which a further single- or double-sided coating takes place. At station 8 it is possible alternatively to emboss the coating or to apply a protective film. Finally, in section 10, the coated metal is cooled to room temperature, followed by quality control (visual inspection of the surface, random samples and tests) at station 11. The metal is finally rewound or, alternatively, cut into lengths or into sheets and packed.

1. Method of coating metal strips, preferably made of steel or aluminum, by applying a powder coating, cleaning and baking, characterized in that
1) the powder coating comprises at least one polyhydroxy-functional resin and/or at least one epoxy resin, and
2) the powder coating has a particle size distribution such that
a) at least 90 percent by mass of the powder coating particles have a size of between 1 and 150, preferably 1 and 100 μm,
b) the maximum size of the powder coating particles for at least 99 percent by mass of the particles is ≦150 μm,
c) the mean size of the powder coating particles is between >5 and 60 μm, preferably 5 and 40 μm, and
d) the slope of the particle distribution curve at the point of inflection is ≧50, preferably ≧100.

2. Method according to claim 1, characterized in that a powder coating is employed which has a particle size distribution that
a) at least 90 percent by mass of the powder coating particles have a size of between 1 and 60 μm, preferably between 1 and 40 μm,
b) the maximum size of the powder coating particles for at least 99 percent by mass of the particles is ≦100 μm, preferably ≦60,
c) the mean size of the powder coating particles is between 5 and 20 μm, preferably between 5 and 12 μm, and
d) the slope of the particle distribution curve at the point of inflection is ≧100 μm, preferably ≧150 μm.

3. Method according to one of claims 1 or 2, characterized in that the powder coating has a particle size distribution such that
a) at least 90 percent by mass of the powder coating particles have a size of between 5 and 25 μm,
b) the maximum size of the powder coating particles for at least 99 percent by mass of the particles is ≦40 μm,
c) the mean size of the powder coating particles is between 5 and 12 μm, and
d) the slope of the particle distribution curve at the point of inflection is ≧200.

4. Method according to one of claims 1 to 3, characterized in that the powder coating, comprises
A) at least one epoxy resin having an epoxide equivalent weight of from 300 to 5500 and
Ba) at least one hardener having more than one phenolic hydroxyl group per molecule and a hydroxyl equivalent weight, based on phenolic OH groups, of from 100 to 500, preferably from 200 to 300, or
Bb) at least one polyester having an acid number of from 25 to 120 mg of KOH/g and an OH number >10 mg of KOH/g, and
C) at least one epoxy resin having an epoxide equivalent weight of from 400 to 3000.

5. Method according to one of claims 1 to 4, characterized in that the powder coating comprises at least one polyester having an acid number of from 30 to 90 mg of KOH/g and an OH number of from 15 to 30 mg of KOH/g and at least one epoxy resin having an epoxide equivalent weight of from 600 to 900.

6. Method according to one of claims 1 to 5, characterized in that the powder coating employed comprises as component A epoxy resins based on bisphenol A and/or epoxidized novolak resins and/or either as component Ba) hardeners having from 1.8 to 4, preferably ≦3 phenolic OH groups per molecule or as component Bb) polyesters based on terephthalic and/or trimellitic acid and ethylene glycol and/or neopentyl glycol.

7. Method according to one of claims 1 to 6, characterized in that the powder coating comprises
from 19 to 80% by weight of the epoxy resin component A,
from 10 to 50% by weight of the hardener component Ba) or
from 19 to 80% by weight of the polyester component Bb)
the percentages being based in each case on the overall weight of the powder coating.

8. Method according to claim 1 to 3, characterized in that the powder coating comprises
A) at least one polyhydroxy-functional resin and
B) at least one polyisocyanate hardener having more than one isocyanate group per molecule.

9. Method according to one of claims 1 to 3 or 8, characterized in that the polyhydroxy-functional resin is selected from the group of the polyester-, polyurether- [sic], polyurethane-, polyacrylate- and/or of the polysiloxanepolyols.

10. Method according to one of claims 1 to 3, 8 or 9, characterized in that the polyhydroxy-functional component A has a hydroxyl number of between 5 and 200 mg of KOH/g.

11. Method according to one of claims 1 to 6, characterized in that the powder coating comprises
A) from 10 to 90% by weight, based on the overall weight of the powder coating, of the polyhydroxy-functional resin component A and
B) from 10 to 80% by weight, based on the overall weight of the powder coating, of the polyisocyanate hardener component B.

12. Method according to claim 11, characterized in that the powder coating additionally comprises
C) from 0.01 to 5% by weight of a curing catalyst,
D) if desired, up to 40% by weight of fillers, and
E) if desired, from 0.01 to 10% by weight of further auxiliaries and additives.

13. Method according to one of claims 1 to 3, characterized in that the powder coating comprises an unsaturated polyester and a polyurethane that contains (meth)acrylic groups.

14. Method according to one of claims 1 to 13, characterized in that a powder coating according to one of claims 1 to 8 having a film thickness of from 7 to 20 μm, preferably from 10 to 15 μm, is applied.
